(19) United States
(12) Patent Application Publication
(10) Pub. No.: US 2008/0202116 A1
(43) Pub. Date: Aug. 28, 2008

(54) Method and Apparatus for Improving the Operation of Positive Displacement Expanders

(76) Inventors: Russell Benstead, Cheshire (GB); Simon James Redford, Chester (GB); Iain James Henshaw, Gloucestershire (GB); James William Derby, Liverpool (GB)

Correspondence Address: Intellectual Property Dept.;Dewitt Ross & Stevens SC, 2 East Mifflin Street, Suite 600, Madison, WI, 53703-2865, US

(21) Appl. No.: 11/817,048

(22) PCT Filed: Feb. 24, 2006
(86) PCT No.: PCT/GB06/00678

§ 371 Date: Aug. 24, 2007

(30) Foreign Application Priority Data
Feb. 26, 2005 (GB) 0504033.2

(51) Int. Cl. F15B 7/08; F15B 7/02

(52) U.S. Cl. 60/538; 60/591

(57) ABSTRACT

A linear or rotary positive displacement expander (10) is fed by compressed gas or vapour from a reservoir (11) by means of a fast acting pulsed flow control valve (12) actuated by a PWM microprocessor (13) which receives input data from the expander (10) and the reservoir (11) to determine the correct operation of the valve (12). By injecting single or multiple controlled volume pulses of gas into the expander (10), the need for additional pressure regulation between the reservoir (11) and the expander (10) is eliminated, and the expander can operate efficiently within its built-in pressure ratio capability whereby the gas or vapour is expanded to be as close as possible to ambient pressure at the outlet of the expander.

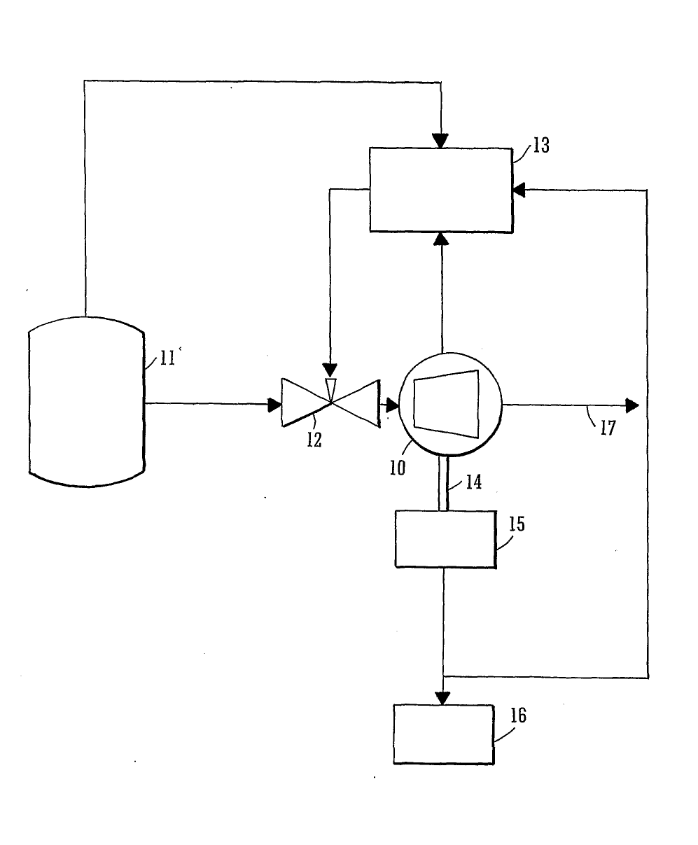

This invention concerns positive displacement expanders and particularly, though not exclusively, the operation of rotary scroll expanders when connected to a supply of compressed air and operable, for example, to drive an electrical generator adapted to supply back-up electrical power in the event of a utility supply failure.

Maximum efficiency when expanding gases or vapours in positive displacement expanders is achieved when the ratio of pressure of the high pressure gas or vapour to the low pressure gas or vapour is approximately equivalent to the inbuilt expansion ratio of the expander. Such expanders include scroll, screw and vane rotary expanders but may also include various kinds of linear expander. If the expander is operated at a very much higher pressure ratio than that of the expander itself, increased torque and hence power can be obtained from the expander, but the isentropic efficiency of the expander is reduced. Conversely, when operating a relatively lower expansion ratios, the gas or vapour is over-expanded which also results in reduced efficiency.

In some systems utilising rotary expanders, gases may be stored at extremely high pressures prior to expansion thus to provide high densities of stored energy. Expanders may typically have expansion ratios in the range of 2-1 to 6-1, and, for example, the stored gas may be established at something like 300 bar whereas the intended inlet pressure of the expander may be as low as 10 bar reducing to 1 bar of expanded gas at the outlet, equivalent to ambient pressure. It is thus normal practice to regulate the high pressure gas prior to entry into the expander, both to achieve pressure ratios closer to that of the expander and also to stay within the pressure tolerance of the expander itself. Pre-regulation of the stored gas pressure represents a considerable loss of work potential.

It is an object of the present invention to enable much more of the work potential of high pressure gases and vapours to be utilised in relatively low-pressure expansion devices and to produce increased isentropic efficiency when expanding gases or vapours having a higher pressure ratio than that of the expander. Furthermore, it is intended to replace the function of regulators and control valves which conventionally are utilised to control the torque or speed or power output of the expansion device so that the dynamic response of such devices may be increased.

According to the present invention there is provided apparatus comprising a positive displacement gas or vapour expander, a supply of pressurised gas or vapour, at least one flow control valve between the supply and the expander, and control means to actuate the flow control valve to determine the flow of gas or vapour from the supply to the expander; characterised in that the flow control valve is a fast acting valve and in that the control means is adapted to deliver a predetermined volume of pressurised gas or vapour to the expander for each operational cycle thereof.

The supply of pressurised gas or vapour may be at least one reservoir containing the gas or vapour at a pressure considerably in excess of that which may be tolerated by the expander.

The control means may be adapted to deliver a volume of pressurised gas or vapour to a chamber of the expander during expansion of the chamber, the delivered volume being determined as less than that of the chamber at the point of entry.

The control means may be adapted to effect pulsed operation of the flow control valve.

The control means may be a PWM microprocessor electrically connected to the flow control valve and programmed to determine the timing and duration of signals to effect pulsed operation of the flow control valve.

The PWM microprocessor may be adapted to receive data representative of operational characteristics of the expander thus accordingly to modulate the pulsed operation of the flow control valve.

The PWM microprocessor may be adapted to receive data representative of the properties of the compressed gas or vapour.

The PWM microprocessor may be adapted to receive data representative of the operation or characteristics of a machine driven by the expander.

The flow control valve may be connected directly, and in close proximity, to the expander inlet.

The flow control valve may be connected directly to the supply of gas or vapour.

A pressure regulator may be interposed between the supply of gas or vapour and the flow control valve.

The expander may be a rotary device.

The expander may be a scroll expander.

The driven machine may be an electrical generator adapted to supply back-up electrical power in the event of a utility supply failure.

According to a further aspect of the present invention there is provided a method of operating a positive displacement expander connected via a flow control valve to a supply of pressurised gas or vapour comprising the steps of causing the flow control valve to deliver to the expander a predetermined volume of pressurised gas or vapour for each operational cycle of the expander.

The gas or vapour may be delivered to a chamber of the expander during expansion thereof and the delivered volume is less than that of the volume of the chamber at the point of entry.

The PWM microprocessor may modulate the pulsed operation of the flow control valve in such a way that the pressure in the chamber of the expander at the point when it is just sealed from the inlet port is optimised for the efficient expansion of gas for the expansion ratio of the expander.

The delivered volume may be less than that of the chamber at the point of entry.

The flow control valve may receive electrical signals from a PWM microprocessor to effect pulsed operation of the flow control valve.

The pulsed operation may comprise a single pulse to deliver a pocket of gas or vapour for each operational cycle of the expander.

The pulsed operation may comprise multiple pulses to deliver multiple pockets of gas or vapour for each operation or cycle of the expander.

The PWM microprocessor may receive data representative of the operational characteristics of the expander and accordingly modulate the pulsed operation of the flow control valve.

The PWM microprocessor may receive data representative of the properties of the compressed gas or vapour and accordingly modulate the pulsed operation of the flow control valve.

The PWM microprocessor may receive data representative of the operational characteristics of a machine driven by the expander, and accordingly modulate the pulsed operation of the flow control valve.

The pressure of the gas or vapour at the supply may be regulated prior to delivery to the expander.

An embodiment of the invention will now be described, by way of example only, with reference to the accompanying drawing which illustrates diagrammatically an apparatus comprising a rotary expander, a supply of compressed gas or vapour, a flow control valve, and control means for operation of the valve.

Referring now to the drawing a rotary expander 10, in this example a scroll expander, is connected to a reservoir 11 of compressed gas. A flow control valve 12 is situated immediately adjacent the inlet of the scroll expander 10 and determines the flow of gas from the reservoir 11 into the expander. The close proximity of the valve 12 to the expander 10 is determined in order to minimise any dead volume between the valve and the expander.

The flow control valve 12 is a fast acting valve such as a solenoid valve, a liquid fuel injector or a piezo electric device, and is capable of pulsed operation thus to delivery single or multiple pockets of gas to the inlet chamber of the expander.

Connected to the valve 12 to actuate same is a PWM microprocessor and signal generator 13.

In this embodiment, the driven output shaft 14 of the expander 10 is drivingly connected to a generator 15 connected to supply back-up electrical power to a load 16 in the event of a failure of the utility electricity supply. However, it will be appreciated that the expander may be utilised to drive other machines, for other purposes.

In accordance with the invention the apparatus is operated such that the high pressure gas from reservoir 11 is introduced via the valve 12 into the expander 10 such that when the gas has expanded through cyclic operation of the expander the pressure of the outlet gas at 17 is as close as possible to ambient pressure ie typically 1 bar.

It will be understood that the pressure of the available gas in reservoir 11 is extremely high, typically 300 bar, and is far in excess of the maximum working pressure, typically 10 bar, of the expander. It is the control valve 12 which is exposed to the full pressure in the reservoir and so the valve 12 is operated thus to permit small pockets of high pressure gas to pass to an expanding chamber of the expander. The PWM microprocessor and signal generator effects this pulsed operation of the valve 12 such that a single or multiple pulses of gas may pass into the expander for each revolution thereof. The volume of each pulse of gas, at the pressure upstream of the valve, entering the chamber of the expander is preferably less than that of the chamber at that point in the cycle and is thus permitted to expand into the chamber and then further as the chamber volume increases such that when the chamber has reached the point where it has just sealed from the inlet valve 12, the pressure will be optimised for the efficient expansion of gas for the expansion ratio of the expander. The single or multiple pulses release a volume of gas into the inlet chamber in a time period prior to that chamber being sealed by rotation of the expander. Such pressure is equivalent to the maximum working pressure of the expander which, in this example, is 10 bar.

In order to determine the operation of the control valve 12, the PWM microprocessor 13 must evaluate certain operational parameters of the system. Accordingly, it is connected to the reservoir 11 to receive data representative of the properties of the compressed gas such as its pressure and temperature.

The microprocessor also receives data representative of the position of the expander within its operational cycle, which data may be used to synchronise the opening of the valve at an optimum position in the expander cycle. This may be to ensure that the valve opens at or near the point when the expander inlet volume starts to open. The synchronisation may be determined by a timing mark on the expander shaft which is read either visually or magnetically or by some other means to produce a signal for the microprocessor. This signal also represents the rotational speed of the expander. A further signal may be received representative of the pressure and/or temperature of the expanded gas leaving the expander at 17, and a further signal may be received representative of the torque/speed/power of the generator 15, or similar characteristics of the load 16. Thus, the PWM microprocessor may be programmed with a control algorithm which thus determines the pulse width, duration and timing of the signal fed to the control valve 12 to actuate same. The algorithm may take account of the rate of change of data from the various sources.

It will be appreciated that certain advantages accrue from the method and apparatus of the invention. Increased efficiency of energy extraction is ensured by the fast acting valve being the only valve required between the reservoir and the expander. Thus, in most cases, the need for a pressure regulator and other valving is eliminated. The injection of a small pocket of high pressure gas which then expands to fill the inlet chamber at the correct moment in time with the correct pressure ensures that once the gas has been expanded and exhausted it is as near as possible to ambient pressure, and this effectively increases the expansion ratio of the expander and hence that of the power output. The pressure ratio is as near as possible to that of the expander itself.

It is not intended to limit the invention to the above example only, many variations being possible without departing from the scope of the invention as determined by the appended claims. For example, in some applications it may be preferable to introduce a pressure regulating valve between the reservoir 11 and the control valve 12 such that the maximum pressure of the gas supplied to the expander can never exceed the operational parameters of the expander, for example in the event of a failure of the microprocessor causing the valve 12 to open fully. While single pulses of gas to the expander are possible, the provision of multiple pulses serves to control the maximum pressure at the inlet port and so acts as the pressure regulator.

In a simplified embodiment of the invention the microprocessor 13 may be replaced by some other device adapted merely to detect the operational position of the expander and to actuate the valve 12 to introduce one/or pulses of gas into the expander inlet.

1. Apparatus comprising a positive displacement gas or vapor expander, a supply of pressurized gas or vapor, at least one flow control valve between the supply and the expander, and a controller to actuate the flow control valve to determine the flow of gas or vapor from the supply to the expander;
wherein the flow control valve comprises a fast acting valve and the controller is dimensioned and configured to deliver a predetermined volume of pressurized gas or vapor to the expander for each operational cycle thereof

2. Apparatus according to claim 1, wherein the supply of pressurized gas or vapor is at least one reservoir containing the gas or vapor at a pressure in excess of that which may be tolerated by the expander.

3. Apparatus according to claim 1 wherein the controller is dimensioned and configured to deliver a volume of pressurized gas or vapor to a chamber of the expander during expansion of the chamber, the delivered volume being determined as less than that of the chamber at the point of entry.

4. Apparatus according to claim 1, wherein the controller is dimensioned and configured to effect pulsed operation of the flow control valve.

5. Apparatus according to claim 1, wherein the controller is a PWM microprocessor electrically connected to the flow control valve and programmed to determine the timing and duration of signals to effect pulsed operation of the flow control valve.

6. Apparatus according to claim 5, wherein the PWM microprocessor is dimensioned and configured to receive data representative of operational conditions of the expander and to modulate the pulsed operation of the flow control valve.

7. Apparatus according to claim 5, wherein the PWM microprocessor is dimensioned and configured to receive data representative of the properties of the compressed gas or vapor.

8. Apparatus according to claim 5, wherein the PWM microprocessor is dimensioned and configured to receive data representative of the operational characteristics of a machine driven by the expander.

9. Apparatus according to claim 1, wherein the flow control valve is connected directly and in close proximity to the expander inlet.

10. Apparatus according to claim 1, wherein the flow control valve is connected directly to the supply of gas or vapor.

11. Apparatus according to claim 1, wherein a pressure regulator is interposed between the supply of gas or vapor, and the flow control valve.

12. Apparatus according to claim 1, wherein the expander is a rotary device.

13. Apparatus according to claim 1, wherein the expander is a scroll expander.

14. Apparatus according to claim 8, wherein the driven machine is an electrical generator dimensioned and configured to supply back-up electrical power in the event of a utility supply failure.

15. Apparatus according to claim 1, wherein the expander is drivingly connected to an electrical generator dimensioned and configured to supply back-up electrical power in the event of a utility supply failure.

16. A method of operating a positive displacement expander connected via a flow control valve to a supply of pressurized gas or vapor, comprising the steps of causing the flow control valve to deliver to the expander a predetermined volume of pressurized gas or vapor for each operational cycle of the expander.

17. A method according to claim 16, wherein the gas or vapor is delivered to a chamber of the expander during expansion thereof and the delivered volume is no greater than that of the volume of the chamber at the point of entry.

18. A method according to claim 16, wherein the flow control valve receives electrical signals from a PWM microprocessor to effect pulsed operation of the flow control valve.

19. A method according to claim 18, wherein the pulsed operation comprises a single pulse to deliver a pocket of gas or vapor for each operational cycle of the expander.

20. A method according to claim 18, wherein the pulsed operation comprises multiple pulses to deliver multiple pockets of gas or vapor for each operation or cycle of the expander.

21. A method according to claim 18, wherein the PWM microprocessor receives data representative of the operational characteristics of the expander and accordingly modulates the pulsed operation of the flow control valve.

22. A method according to claim 18, wherein the PWM microprocessor modulates the pulsed operation of the flow control valve in such a way that the pressure in the chamber of the expander at the point when it is just sealed from the inlet port is optimized for the efficient expansion of gas for the expansion ratio of the expander.

23. A method according to claim 18, wherein the PWM microprocessor receives data representative of the properties of the compressed gas or vapor and accordingly modules the pulsed operation of the flow control valve.

24. A method according to claim 18, wherein the PWM microprocessor receives data representative of the operational characteristics of a machine driven by the expander, and accordingly modulates the pulsed operation of the flow control valve.

25. A method according to claim 16, wherein the pressure of gas or vapor present at the supply is regulated prior to delivery to the expander.
